(19) United States
(12) Patent Application Publication
(10) Pub. No.: US 2019/0017515 A1
(43) Pub. Date: Jan. 17, 2019

(54) BLOWER

(71) Applicant: DENSO CORPORATION, Kariya-city, Aichi-pref. (JP)

(72) Inventors: Yasuhiro SEKITO, Kariya-city (JP); Shinya KATO, Kariya-city (JP)

(73) Assignee: Denso Corporation, Kariya-city, Achi-pref. (JP)

(21) Appl. No.: 16/068,175

(22) PCT Filed: Jan. 6, 2017
(86) PCT No.: PCT/JP2017/000235

§ 371 Date: Jul. 5, 2018

(30) Foreign Application Priority Data
Jan. 7, 2016 (JP) 2016-001838

(51) Int. Cl. F04D 29/28; F04D 29/44; B60H 1/00

(52) U.S. Cl. CPC F04D 29/281; F04D 29/44; B60H 1/00564; B60H 1/00064; B60H 2001/00092; B60H 1/00028

(57) ABSTRACT

A blower configured to suction and discharge first fluid and second fluid includes a fan and a division wall. The fan is configured to rotate relative to the division wall. The division wall is spaced from the fan and positioned in a suction space, the division wall partitioning the suction space into a space through which the first fluid passes and a space through which the second fluid passes. The division wall includes a base and a widened portion. The base guides flows of the first fluid and the second fluid toward the fan. In the suction space, the widened portion is closer to a rotation area of the fan than the base is. A width of the widened portion in a direction along a thickness of an end of the base connected to the widened portion is larger than the thickness of the end of the base.

### CROSS REFERENCE TO RELATED APPLICATION

This application is based on and incorporates herein by reference Japanese Patent Application No. 2016-1838 filed on Jan. 7, 2016.

### TECHNICAL FIELD

The present disclosure relates to a blower.

### BACKGROUND ART

Conventionally, as described in Patent Literature 1, there is a blower that suctions and discharges first fluid and second fluid, and includes a partition wall in order to separate the first fluid and the second fluid from each other.

### PRIOR ART DOCUMENT

### Patent Literature

Patent Literature 1: WO 2015/075912 A1

### SUMMARY OF THE INVENTION

Hard studies by the present inventors show that, in Patent Literature 1, a clearance between a rotation area of a fan and the partition wall causes the first fluid and the second fluid to mix together in the clearance. Consequently, the technique in Patent Literature 1 has a lower performance in separating the first fluid and the second fluid from each other.

It is an object of the present disclosure to provide a blower that suctions and discharges first fluid and second fluid and includes a division wall with a higher performance in separating the first fluid and the second fluid than that of conventional ones.

According to an aspect of the present disclosure, a blower configured to suction and discharge first fluid and second fluid includes a fan and a division wall. The fan is configured to rotate relative to the division wall to suction and discharge the first fluid and the second fluid. The division wall is spaced from the fan and positioned in a suction space through which the first fluid and the second fluid are suctioned by the fan and pass, the division wall partitioning the suction space into a space through which the first fluid passes and a space through which the second fluid passes. The division wall includes a base and a widened portion. The base is a plate located in the suction space and is configured to guide flows of the first fluid and the second fluid toward the fan. The widened portion is connected to the base in the suction space, in the suction space. The widened portion is closer to a rotation area of a certain part of the fan than the base is. A width of the widened portion in a direction along a thickness of an end of the base connected to the widened portion is larger than the thickness of the end of the base.

In this manner, the width of the widened portion in the thickness direction of the end of the base is greater than the thickness of the end. In this way, the widened portion separates the first fluid and the second fluid from each other with a longer distance than the thickness of the base. Therefore, the first fluid and the second fluid being mixed each other in a space between the widened portion and the fan is suppressed. As a result, it is possible to obtain a higher performance in separating the first fluid and the second fluid than that of the conventional one.

### BRIEF DESCRIPTION OF THE DRAWINGS

FIG. 1 is a schematic cross-sectional view illustrating a whole configuration of an air conditioning device for a vehicle including a humidification device according to a first embodiment.

FIG. 2 is a perspective view illustrating a relevant part of the humidification device according to the first embodiment.

FIG. 3 is a perspective view of a humidifier blower.

FIG. 4 is a cross-sectional view of the humidifier blower.

FIG. 5 is a cross-sectional view of the humidifier blower.

FIG. 6 is a cross-sectional view taken along line VI-VI in FIG. 5.

FIG. 7 is a cross-sectional view taken along line VII-VII in FIG. 5.

FIG. 8 is a perspective view of a division wall.

FIG. 9 is a diagram illustrating distribution of humidified air and dehumidified air.

FIG. 10 is a cross-sectional view taken along line VII-VII in FIG. 5 in a second embodiment.

FIG. 11 is a cross-sectional view taken along line VII-VII in FIG. 5 in a third embodiment.

FIG. 12 is a cross-sectional view taken along line VII-VII in FIG. 5 in a fourth embodiment.

FIG. 13 is a cross-sectional view of a humidifier blower in a fifth embodiment.

FIG. 14 is a cross-sectional view taken along line VII-VII in FIG. 5 in the fifth embodiment.

FIG. 15 is a perspective view of a division wall in the fifth embodiment.

### EMBODIMENTS FOR EXPLOITATION OF THE INVENTION

### First Embodiment

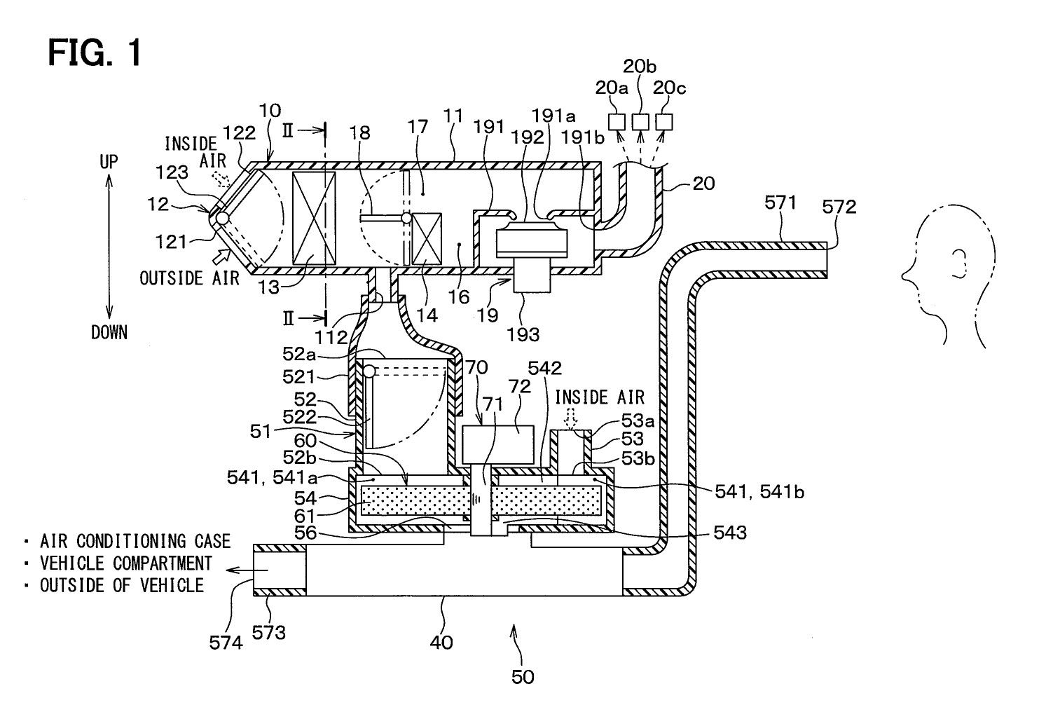

A first embodiment will be described below. In the present embodiment, an example in which an air conditioning device for a vehicle is applied to a vehicle whose driving force for traveling is obtained from an internal combustion engine (not shown) will be described. As shown in FIG. 1, the air conditioning device for a vehicle includes an air conditioning unit 10 and a humidification device 50 as main components. Arrows representing up and down in FIG. 1 represent upward and downward directions of the air conditioning device for a vehicle mounted on the vehicle.

The air conditioning unit 10 is disposed in a dashboard in a vehicle compartment, for example. The air conditioning unit 10 includes an air conditioning case 11 and various parts (e.g., an evaporator 13 and a heater core 14) housed in the air conditioning case 11. The air conditioning case 11 is a resin member that forms a ventilating path for air to be blown into the vehicle compartment.

In a most upstream part of the ventilating path in the air conditioning case 11 with respect to an air flow, an inside-outside air switching box 12 that introduces air outside the vehicle compartment (i.e., outside air) and air inside the vehicle compartment (i.e., inside air) is disposed. The inside-outside air switching box 12 is provided with an outside air introducing port 121 that introduces the outside air and an inside air introducing port 122 that introduces the inside air.

Inside the inside-outside air switching box 12, an inside-outside air switching door 123 that adjusts opening areas of the respective introducing ports 121 and 122 to change a ratio between an introduced amount of the outside air and an introduced amount of the inside air is disposed. The inside-outside air switching door 123 is driven by an actuator (not shown).

On an air flow downstream side of the inside-outside air switching box 12 in the ventilating path in the air conditioning case 11, the evaporator 13 that cools the air to be blown into the vehicle compartment is disposed. The evaporator 13 is a heat exchanger that absorbs latent heat of evaporation of low-temperature refrigerant flowing inside the evaporator 13 from the air to be blown to cool the air. The evaporator 13 constitutes a vapor compression refrigeration cycle together with a compressor, a condenser, and a pressure reducing mechanism (not shown). The refrigeration cycle is a part of the air conditioning unit.

On the air flow downstream side of the evaporator 13, a warm air passage 16 through which the air cooled by the evaporator 13 flows toward the heater core 14 and a cold air bypass passage 17 through which the air cooled by the evaporator 13 bypasses the heater core 14 are formed. The heater core 14 is a heat exchanger that heats the blown air by using, as a heat source, cooling water cooling the above-described internal combustion engine.

An air mix door 18 is pivotably disposed between the evaporator 13 and the heater core 14. The air mix door 18 adjusts a ratio between the air flowing through the warm air passage 16 and the air flowing through the cold air bypass passage 17 to adjust a temperature of the air to be blown into the vehicle compartment. The air mix door 18 is driven by an actuator (not shown).

An air conditioning blower 19 is located downstream of the warm air passage 16 and the cold air bypass passage 17. The air conditioning blower 19 generates an air flow to be blown into the vehicle compartment in the air conditioning case 11. The air conditioning blower 19 includes a blowing case 191, an air conditioning fan 192, and an air conditioning motor 193.

The blowing case 191 constitutes a part of the air conditioning case 11. The blowing case 191 is provided with a suction port 191a for the air and a discharge port 191b that discharges the air suctioned through the suction port 191a.

The air conditioning fan 192 suctions the blown air on the air flow downstream side of the warm air passage 16 and the cold air bypass passage 17 through the suction port 191a, and discharges the blown air from the discharge port 191b. The air conditioning fan 192 is driven to rotate by the air conditioning motor 193.

An air conditioning duct 20 is connected to the discharge port 191b of the air conditioning blower 19. The air conditioning duct 20 introduces the blown air to a face discharge port 20a, a foot discharge port 20b, and a defogger discharge port 20c which are disposed at an air flow downstream end of the air conditioning duct 20.

The face discharge port 20a is a discharge port for discharging the air toward an occupant's upper body. The foot discharge port 20b is a discharge port for discharging the air toward an occupant's lower body. The defogger discharge port 20c is a discharge port for discharging the air toward a vehicle windshield. The air conditioning duct 20 is provided with a mode switching door (not shown) that switches between opening and closing of the discharge ports 20a, 20b, and 20c.

The air conditioning case 11 is provided with a cold air outlet 112. The cold air outlet 112 is an opening that leads a part of the blown air (hereinafter also referred to as cooled air) cooled by the evaporator 13 in the air conditioning case 11 to an outside of the air conditioning case 11. The cold air outlet 112 is formed at a portion of the air conditioning case 11 between the evaporator 13 and the heater core 14.

As described above, the air conditioning unit 10 is so-called suction type in which the air conditioning blower 19 is disposed on the air flow downstream side in the air conditioning case 11. Therefore, a pressure inside the air conditioning case 11 is lower than a pressure outside the air conditioning case 11, i.e., an atmospheric pressure.

Next, the humidification device 50 will be described. The humidification device 50 is disposed below the air conditioning case 11 inside the dashboard and at a lower portion of an instrument panel.

The humidification device 50 includes an adsorption case 51, a humidifier blower 40, an adsorber 60, a drive member 70, a first partition member 542, and a second partition member 543. The adsorption case 51 is a resin casing forming an outer shell of the humidification device 50. The adsorption case 51 houses the adsorber 60, and defines therein a ventilating path for the air to be blown. The adsorption case 51 is a component separate from the air conditioning case 11 and independent of the air conditioning case 11. The adsorption case 51 includes a cold air suction unit 52, an inside air suction unit 53, an adsorber housing unit 54, and an air emitting unit 56.

The cold air suction unit 52 is a pipe, and at opposite ends thereof, a first outside introducing port 52a communicating with an outside of the humidification device 50 and a first inside communicating port 52b communicating with a hygroscopic space 541a (described later) of the adsorber housing unit 54 are formed.

The cold air suction unit 52 includes a cold air door 522 pivotably disposed between the first outside introducing port 52a and the first inside communicating port 52b. The cold air door 522 is driven by an actuator (not shown). The cold air door 522 opens to connect the first outside introducing port 52a and the first inside communicating port 52b to each other, and closes to disconnect the first outside introducing port 52a and the first inside communicating port 52b from each other.

The inside air suction unit 53 is a pipe, and at opposite ends thereof, a second outside introducing port 53a communicating with the outside of the humidification device 50 and a second inside communicating port 53b communicating with the desorption space 541b (described later) of the adsorber housing unit 54 are formed. In the dashboard, the second outside introducing port 53a of the inside air suction unit 53 is open. Therefore, the inside air is introduced from the second outside introducing port 53a to the inside air suction unit 53.

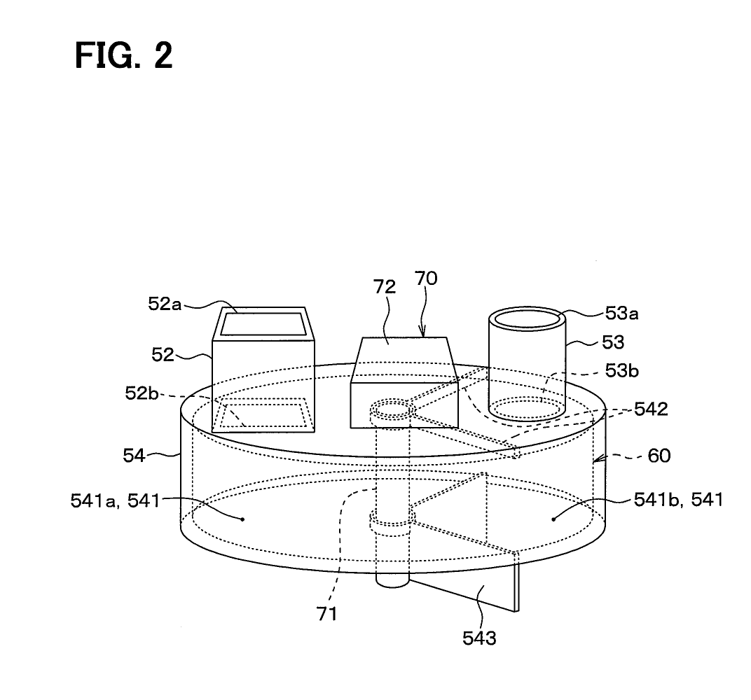

The adsorber housing unit 54 is a member constituting a portion of the adsorption case 51 that houses the adsorber 60. As shown in FIG. 2, an adsorber housing space 541 is formed in the adsorber housing unit 54. The adsorber 60 is disposed in the adsorber housing space 541.

The adsorber housing space 541 includes a space through which the cooled air introduced through the cold air suction unit 52 flows and a space through which the inside air introduced through the inside air suction unit 53 flows. Specifically, the adsorber housing space 541 is partitioned into the space through which the cooled air flows and the space through which the inside air flows, by the first and second partition members 542, 543 respectively provided on the air flow upstream side and the air flow downstream side of the adsorber 60.

The first partition member 542 is provided on the air flow upstream side of the adsorber 60 to partition the space on the air flow upstream side of the adsorber 60 into a flow path for the cooled air and a flow path for the inside air. The first partition member 542 is formed on an inner side of an upper face of the adsorber housing unit 54, i.e., a side facing the adsorber 60.

More specifically, the first partition member 542 includes an annular ring and two plate members. The ring surrounds a rotating shaft 71 (described later) right outside the rotating shaft 71. The ring is not fixed to the rotating shaft 71, and is not in contact with the rotating shaft 71. The two plate members each extend in a radial direction of the rotating shaft 71, from the ring to an outermost peripheral portion of the adsorber housing space 541 that is the farthest from the rotating shaft 71. An angle between the two plate members extending in the radial directions from the rotating shaft 71 is 120°, for example.

The second partition member 543 is provided on the air flow downstream side of the adsorber 60 to partition the space on the air flow downstream side of the adsorber 60 into a flow path for the cooled air and a flow path for the inside air. The second partition member 543 is formed on an inner side of a bottom face of the adsorber housing unit 54.

More specifically, the second partition member 543 includes an annular ring and two plate members. The ring surrounds the rotating shaft 71 right outside the rotating shaft 71. The ring is not fixed to the rotating shaft 71, and is not in contact with the rotating shaft 71. The two plate members each extend in the radial direction of the rotating shaft 71, from the ring to the outermost peripheral portion of the adsorber housing space 541 that is the farthest from the rotating shaft 71. An angle between the two plate members extending in the radial directions from the rotating shaft 71 is 120°, for example.

In the adsorber housing space 541, the adsorber 60 is disposed across both the space through which the cooled air flows and the space through which the inside air flows. The space in the adsorber housing unit 54 through which the cooled air flows is the hygroscopic space 541a where moisture contained in the cooled air is adsorbed onto an adsorbent 61 of the adsorber 60. The space in the adsorber housing unit 54 through which the inside air flows is a desorption space 541b where the moisture adsorbed onto the adsorbent 61 of the adsorber 60 is desorbed to humidify the inside air.

The air emitting unit 56 defines a single hole communicating with both of the hygroscopic space 541a and the desorption space 541b of the adsorber housing unit 54. Dehumidified air resulted from the air passing through the hygroscopic space 541a to be removed its moisture and humidified air resulted from the air passing through the desorption space 541b to be humidified are discharged to an outside of the adsorption case 51 through the hole with the dehumidified air and the humidified air separated from each other.

The air emitting unit 56 is connected to the humidifier blower 40. Therefore, the dehumidified air and the humidified air discharged to the outside of the adsorption case 51 through the hole are suctioned into the humidifier blower 40.

The humidifier blower 40 suctions the dehumidified air and the humidified air from the adsorption case 51 through the hole surrounded by the air emitting unit 56 with the dehumidified air and the humidified air kept separated from each other. The humidifier blower 40 discharges the suctioned humidified air into a humidification duct 571, and discharges the suctioned dehumidified air into a dehumidified air duct 573. The dehumidified air corresponds to the first fluid, and the humidified air corresponds to the second fluid. The dehumidified air and the humidified air have different properties, because the dehumidified air and the humidified air are conditioned in different ways.

The humidification duct 571 leads the humidified air that is the inside air humidified in the desorption space 541b in the adsorption case 51 into the vehicle compartment. The humidification duct 571 in the present embodiment is a separate component from the air conditioning duct 20 that is a discharge duct of the air conditioning unit 10.

A discharge opening 572, which is a downstream end of the humidification duct 571, is provided at a portion of the instrument panel near an occupant's face, and is oriented toward a headrest of a driver's seat. In this way, the humidified air flowing through the humidification duct 571 is discharged from the discharge opening 572 toward the occupant's face. As a result, a space around the occupant's face is humidified.

The dehumidified air duct 573 leads the dehumidified air that is the cooled air removed its moisture in the hygroscopic space 541a in the adsorption case 51. An opening 574 of the dehumidified air duct 573 is formed in a portion to which the dehumidified air is led by the dehumidified air duct 573, and is oriented toward an inside of the dashboard, an outside of the vehicle, or an inside of the air conditioning case 11. In this way, the dehumidified air is not directly discharged toward the occupant.

The adsorber 60 includes multiple plate members (not shown) on which the adsorbent 61 adsorbing and desorbing moisture is supported. The adsorbent 61 is a high polymeric adsorbent that adsorbs or desorbs the moisture depending on a relative humidity difference. The adsorbent 61 adsorbs the moisture in the air when the air with a high relative humidity passes, and discharges the moisture into the air when the air with a low relative humidity passes.

The drive member 70 is a moving mechanism that moves the adsorbent 61 of the adsorber 60 between the hygroscopic space 541a and the desorption space 541b. The drive member 70 includes the rotating shaft 71 extending through a center of the adsorber 60 and connected to the adsorber 60, and an electric motor 72 that rotationally drives the rotating shaft 71. The rotating shaft 71 is rotatably supported on the adsorption case 51, and rotates with the adsorber 60 in the adsorption case 51 when a driving force is transmitted to the rotating shaft 71 from the electric motor 72. In this way, a part of the adsorbent 61 in the desorption space 541b moves into the hygroscopic space 541a in the adsorber 60, and a part of the adsorbent 61 in the hygroscopic space 541a moves into the desorption space 541b in the adsorber 60.

The electric motor 72 continuously rotationally drives the rotating shaft 71 in one direction. In this way, the adsorbent 61 from which the moisture is desorbed sufficiently in the desorption space 541b in the adsorber 60 can move into the hygroscopic space 541a, and at the same time, the adsorbent 61 onto which the moisture is adsorbed sufficiently in the hygroscopic space 541a in the adsorber 60 can move into the desorption space 541b.

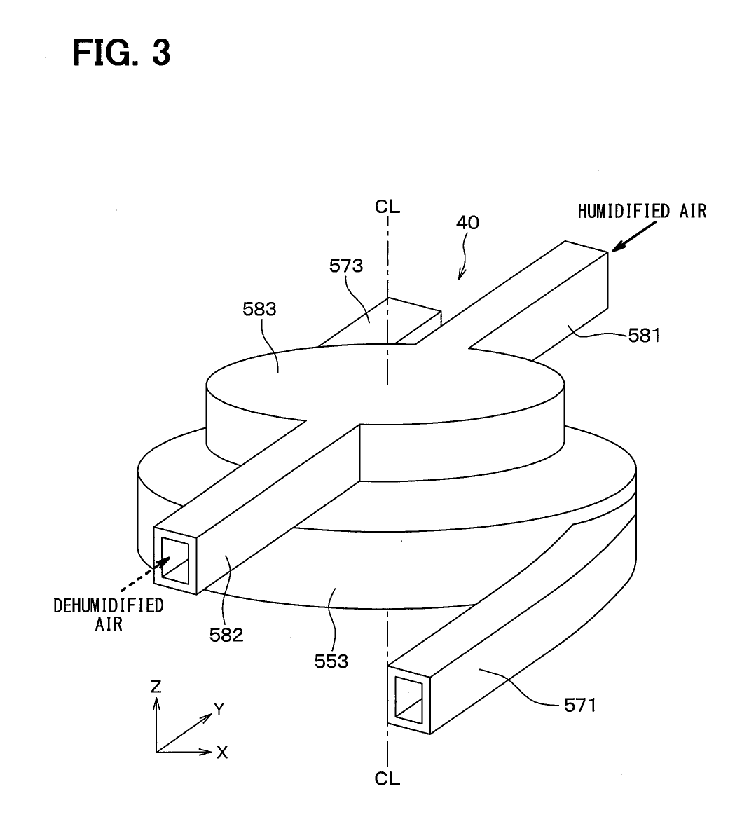

Here, details of the humidifier blower 40 will be described. As shown in FIG. 3, the humidifier blower 40 includes a first connecting duct 581, a second connecting duct 582, a first casing 583, and a second casing 553. The humidifier blower 40 suctions the dehumidified air and the humidified air in a direction toward a fan center axis CL, and separately blows out the dehumidified air and the humidified air in multiple directions away from the fan center axis CL to different spaces.

Both the first connecting duct 581 and the second connecting duct 582 are pipes. The adsorber housing space 541 communicates with a passage in the first connecting duct 581 and a passage in the second connecting duct 582 via the air emitting unit 56 of the adsorption case 51.

More specifically, a portion of the hygroscopic space 541a on the downstream side of the adsorber 60 and a portion of the desorption space 541b on the downstream side of the adsorber 60 are separated from each other by the second partition member 543.

A portion of the desorption space 541b on the downstream side of the adsorber 60 communicates with a space in the first connecting duct 581 via the air emitting unit 56, and does not communicate with a space in the second connecting duct 582. A portion of the hygroscopic space 541a on the downstream side of the adsorber 60 communicates with the space in the second connecting duct 582 via the air emitting unit 56, and does not communicate with the space in the first connecting duct 581.

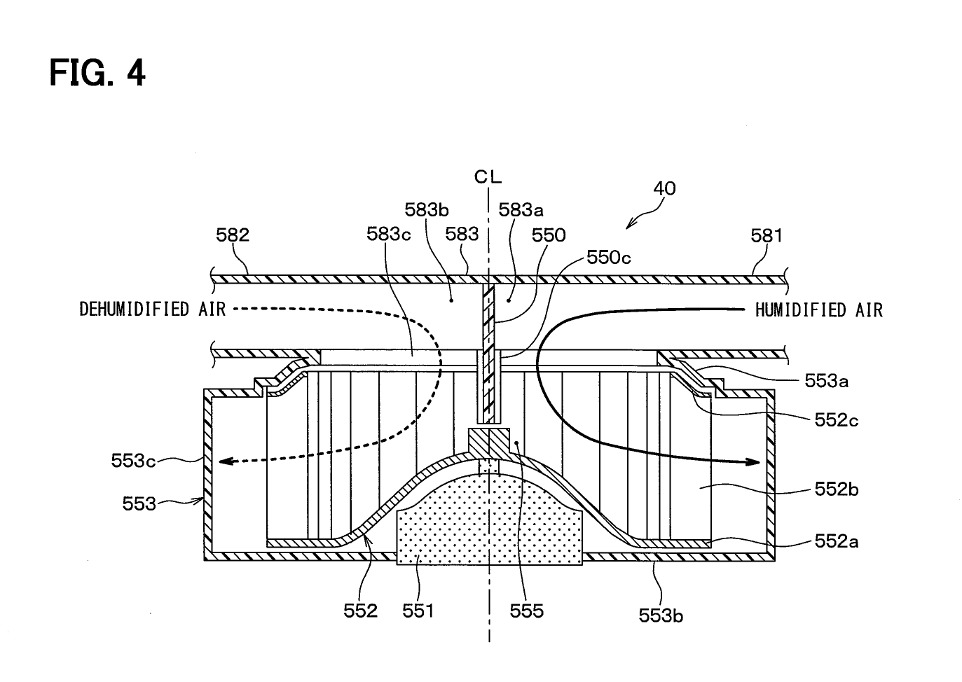

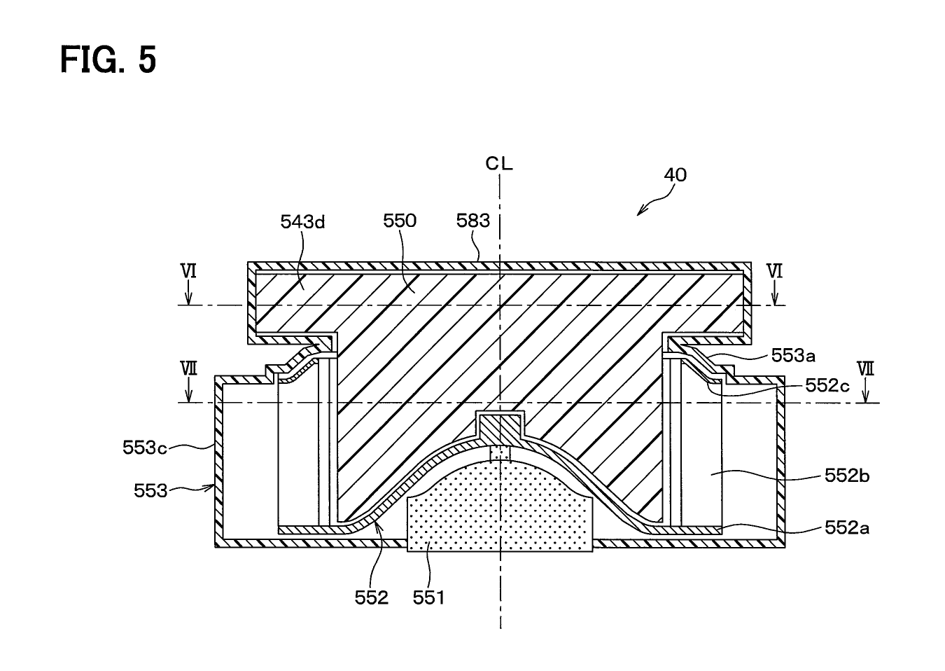

The first connecting duct 581 and the second connecting duct 582 extend without interconnecting their inner passages, and are connected to the first casing 583 as shown in FIG. 3. As shown in FIGS. 4 and 5, the first casing 583 defines therein an inflow space having a disc shape. A central axis of the disc shape and the fan center axis CL of the humidifier blower 40 are aligned with each other.

The second casing 553 is connected to the first casing 583, and defines therein a fan housing space. As shown in FIGS. 4 and 5, the fan housing space and the inflow space in the first casing 583 communicate with each other.

FIG. 4 is a cross-sectional view of the humidifier blower 40 taken along a plane including the fan center axis CL and perpendicular to an X-axis direction in FIG. 3. FIG. 5 is a cross-sectional view of the humidifier blower 40 taken along a plane including the fan center axis CL and perpendicular to a Y-axis direction in FIG. 3.

As shown in FIGS. 4 and 5, the humidifier blower 40 further includes a division wall 550, a motor 551, and a centrifugal fan 552.

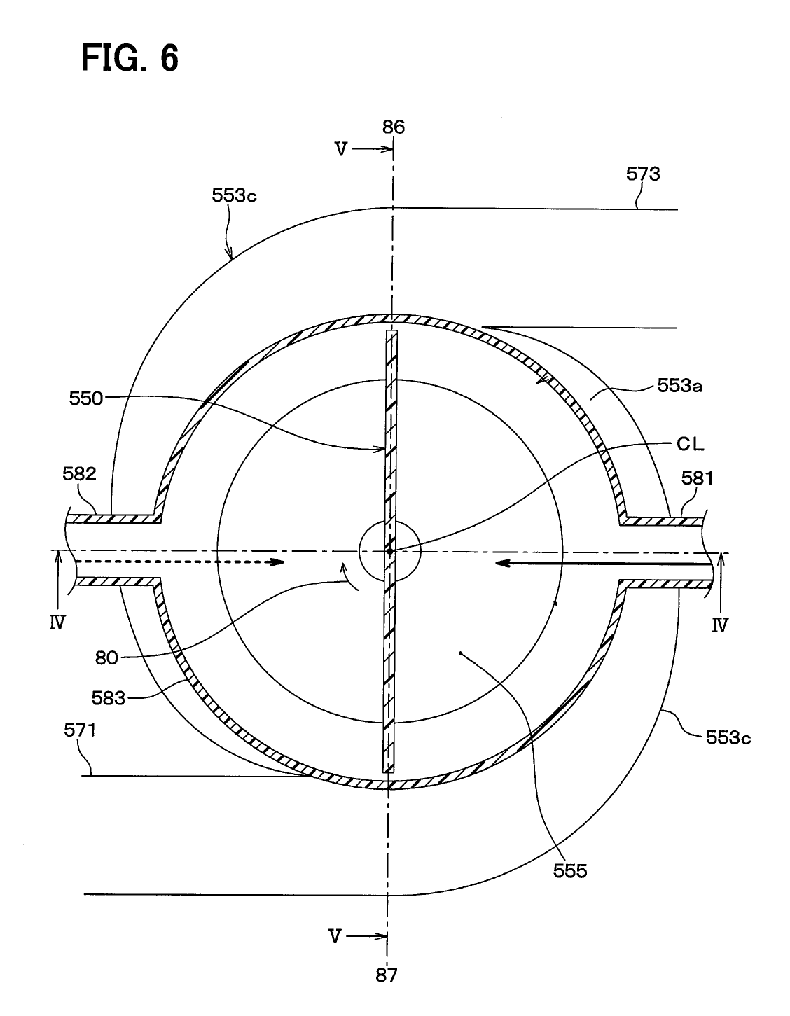

The division wall 550 is a plate member, and is disposed in both the inflow space in the first casing 583 and the fan housing space in the second casing 553. The division wall 550 is disposed with a clearance from the centrifugal fan 552. The division wall 550 is fixed to an inner face of the first casing 583 with an adhesive or the like. Unlike the centrifugal fan 552, the division wall 550 does not rotate. In other words, the centrifugal fan 552 rotates relative to the division wall 550. As shown in FIGS. 4 and 6, the division wall 550 partitions the inflow space in the first casing 583 into a humidified air space 583a and a dehumidified air space 583b.

Therefore, the humidified air flowing out of the desorption space 541b and passing through the first connecting duct 581 flows into the humidified air space 583a without mixing with the dehumidified air. The dehumidified air flowing out of the hygroscopic space 541a and passing through the second connecting duct 582 flows into the dehumidified air space 583b without mixing with the humidified air.

A part of the motor 551 is housed in the second casing 553, and the remaining parts are exposed to an outside from the second casing 553. An output shaft of the motor 551 is connected to the centrifugal fan 552. A rotational driving force of the motor 551 is transmitted from the output shaft to the centrifugal fan 552 to rotate the centrifugal fan 552 about the fan center axis CL.

The centrifugal fan 552 is a sirocco fan. The centrifugal fan 552 is disposed in the fan housing space in the second casing 553, and includes a fan boss 552a, multiple blades 552b, and a top plate 552c. The centrifugal fan 552 suctions the dehumidified air in the humidified air space 583a and the humidified air in the dehumidified air space 583b in the direction toward the fan center axis CL, and radially discharges the dehumidified air and the humidified air in multiple directions away from the fan center axis CL.

The fan boss 552a has a plate shape, and is connected to the output shaft of the motor 551. The fan boss 552a has an axisymmetric shape with the fan center axis CL on its symmetry axis. A face of the fan boss 552a closer to the division wall 550 protrudes farther toward the division wall 550 as coming closer to the fan center axis CL.

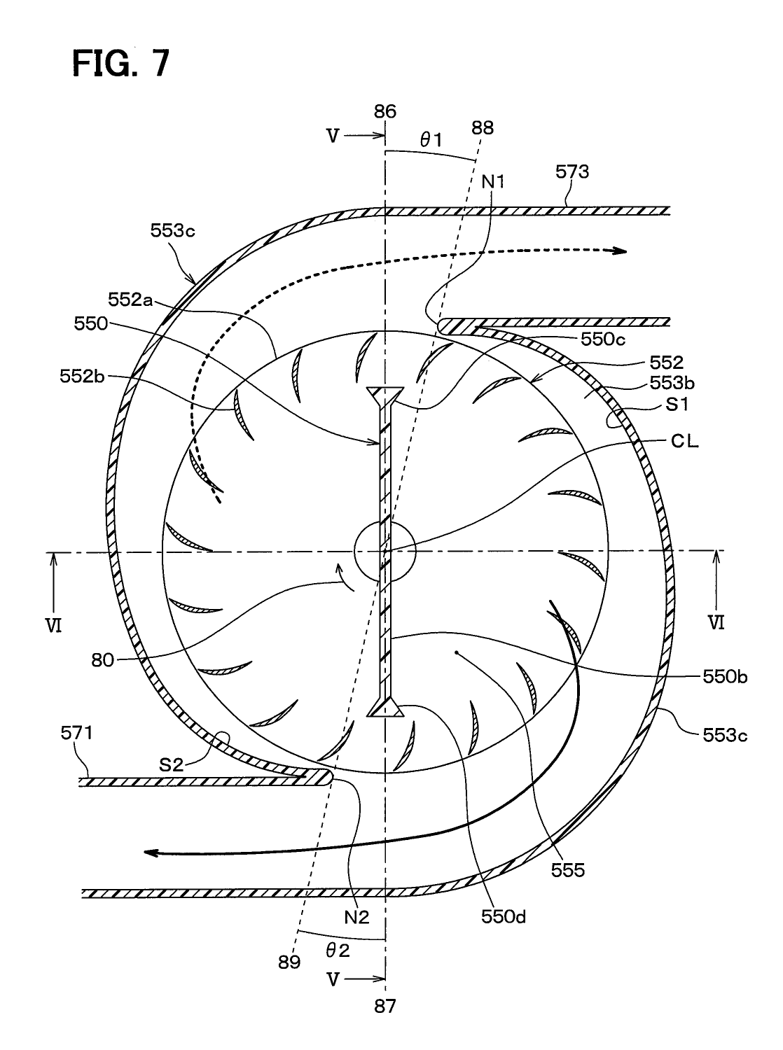

As shown in FIG. 7, the blades 552b are disposed at regular intervals in a circumferential direction around a fan suction space 555 having a columnar shape with the fan center axis CL in its center. The fan suction space 555 is a part of the above-described fan housing space, and includes the fan center axis CL and a space around the fan center axis CL.

Each of the blades 552b is connected and fixed to the fan boss 552a perpendicularly to the fan boss 552a. Each of the blades 552b rotates about the fan center axis CL to send the air in the fan suction space 555 in directions away from the fan center axis CL. The top plate 552c has an annular plate shape, and faces the fan boss 552a across the blades 552b. All of the blades 552b are connected and fixed to the top plate 552c.

Here, the second casing 553 will be further described. The second casing 553 has such a shape as to separately discharge the humidified air having passed through the humidified air space 583a and the dehumidified air resulted having passed through the dehumidified air space 583b into the dehumidified air duct 573 and the humidification duct 571, respectively.

The second casing 553 includes an upper bottom wall 553a, a lower bottom wall 553b, and an outer peripheral wall 553c. The upper bottom wall 553a has a plate shape corresponding to an upper lid of the second casing 553, and has an opening connected to the first casing 583 at an inner peripheral end thereof. The opening defines a hole for introducing the humidified air from the humidified air space 583a and for introducing the dehumidified air from the dehumidified air space 583b. The lower bottom wall 553b has a plate shape, and faces the upper bottom wall 553a in the direction along the fan center axis CL.

The outer peripheral wall 553c has a plate shape, and forms an outer periphery of the second casing 553. The outer peripheral wall 553c is connected at an upper end thereof to an outer peripheral end of the upper bottom wall 553a, and is connected at a lower end thereof to an outer peripheral end of the lower bottom wall 553b. Therefore, the outer peripheral wall 553c connects the upper bottom wall 553a and the lower bottom wall 553b.

As shown in FIG. 7, an inner face of the outer peripheral wall 553c facing the fan housing space has two scroll noses, i.e., a first nose N1 and a second nose N2. The inner face of the outer peripheral wall 553c includes a first scroll inner wall face S1 and a second scroll inner wall face S2.

The first nose N1 is connected to an end of the first scroll inner wall face S1 which is an end in a direction opposite to a rotating direction 80 of the centrifugal fan 552. The second nose N2 is connected to an end of the second scroll inner wall face S2 which is an end in the direction opposite to a rotating direction 80 of the centrifugal fan 552.

The first nose N1 defines a border between the inner face of the outer peripheral wall 553c and the dehumidified air duct 573, and is a starting portion of winding of the scroll. The second nose N2 defines a border between the inner face of the outer peripheral wall 553c and the humidification duct 571, and is a starting portion of winding of the scroll.

The first scroll inner wall face S1 extends from the first nose N1 to the humidification duct 571 in a scroll shape surrounding the fan center axis CL so that a distance from the fan center axis CL to the first scroll inner wall face S1 increases in accordance with a known logarithmic spiral function with respect to a winding angle from the fan center axis CL.

The second scroll inner wall face S2 extends from the second nose N2 to the dehumidified air duct 573 in a scroll shape surrounding the fan center axis CL so that a distance from the fan center axis CL to the second scroll inner wall face S2 increases in accordance with the known logarithmic spiral function with respect to a winding angle from the fan center axis CL.

In this manner, two outlets are provided in the second casing 553. One of the two outlets is connected to the humidification duct 571, and the other of the two outlets is connected to the dehumidified air duct 573.

Here, a relationship between an arrangement of the division wall 550 and shapes of the second casing 553, the humidification duct 571, and the dehumidified air duct 573 will be described. As shown in FIGS. 4, 5, and 7, a lower portion of the division wall 550 is disposed in the fan suction space 555. In this way, the division wall 550 partitions the fan suction space 555 into two spaces. One of the two spaces is a space through which the humidified air passes to be suctioned into the centrifugal fan 552 and through which the dehumidified air does not pass. The other of the two spaces is a space through which the dehumidified air passes to be suctioned into the centrifugal fan 552 and through which the humidified air does not pass. That is, a flow rate of the humidified air in the one of the two spaces is much higher than that of the dehumidified air, and a flow rate of the dehumidified air in the other of the two spaces is much higher than that of the humidified air.

More specifically, as shown in FIG. 7, an angle between directions 86, 87, in which the division wall 550 extends straight away from the fan center axis CL in a plane perpendicular to the fan center axis CL, is 180°. An angle between a direction 88 from the fan center axis CL toward the first nose N1 and a direction 89 from the fan center axis CL toward the second nose N2 in the plane perpendicular to the fan center axis CL is also 180°.

The direction 86 of the division wall 550 is deviated to a direction opposite from the rotating direction 80 of the centrifugal fan 552 by a first deviation angle 81 that is larger than 0° and smaller than 90° from the direction 88 toward the first nose N1. The direction 87 of the division wall 550 is deviated to a direction opposite from the rotating direction 80 of the centrifugal fan 552 by a second deviation angle 82 that is substantially the same from the direction 89 toward the second nose N2. The direction 86 and the direction 89 are deviated from each other, and the direction 87 and the direction 88 are deviated from each other.

Here, the shape of the division wall 550 will be described in further detail with reference to FIGS. 4, 5, 7, and 8. The division wall 550 includes an upper base 550a, a lower base 550b, a first blade-side widened portion 550c, and a second blade-side widened portion 550d. The members 550a, 550b, 550c, and 550d may be molded integrally.

The upper base 550a is an entire portion of a part of the division wall 550 which is housed in the inflow space in the first casing 583. The upper base 550a has a flat plate shape. A plate face of the upper base 550a is parallel to the fan center axis CL.

The lower base 550b is a flat plate part of the division wall 550 which is housed in the fan suction space 555 in the second casing 553. The lower base 550b is the plate that guides flows of the first fluid and the second fluid toward the fan boss 552a and the blades 552b of the centrifugal fan 552 in the suction space. The lower base 550b has a constant thickness. The lower base 550b extends in a direction passing through the fan center axis CL and away from the fan center axis CL, and extends in a direction from a border between the first casing 583 and the second casing 553 toward the fan boss 552a.

An upper end of the lower base 550b is connected to a lower end of the upper base 550a. The upper base 550a and the lower base 550b are formed as a single flat plate as a whole. The lower base 550b has a greater width than that of the upper base 550a in a direction orthogonal to the fan center axis CL. An end of the lower base 550b closer to the fan boss 552a (i.e., a lower end) is not in contact with the fan boss 552a, and leaves a small clearance from the fan boss 552a. The lower end of the lower base 550b has a shape conforming to a shape of a surface of the fan boss 552a closer to the lower base 550b.

The first blade-side widened portion 550c is housed in the fan suction space 555, and is fixed to one end of the lower base 550b in the direction orthogonal to the fan center axis CL. Therefore, the first blade-side widened portion 550c is connected to the lower base 550b, and is disposed at a farther position from the fan center axis CL than the lower base 550b. In other words, in the fan suction space 555, the first blade-side widened portion 550c is closer to a rotation area of the blades 552b than the lower base 550b. The rotation area is a set of positions through which at least a part of a given object passes when the object rotates 360° about an axis. In the present embodiment, the blades 552b correspond to a certain part of the centrifugal fan 552. The first blade-side widened portion 550c corresponds to a first widened portion.

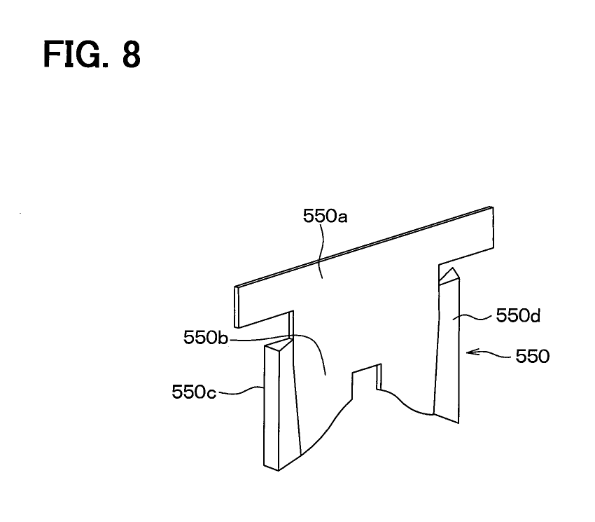

As shown in FIGS. 7 and 8, a width of the first blade-side widened portion 550c in the circumferential direction of the fan center axis CL is greater than that of any part of the lower base 550b.

Here, widths of respective parts of the first blade-side widened portion 550c will be described. Here, the widths of the respective parts of the first blade-side widened portion 550c are widths in a thickness direction of the end of the lower base 550b connected to the respective parts. The respective parts of the first blade-side widened portion 550c are parts obtained by dividing the first blade-side widened portion 550c by multiple planes orthogonal to the center axis CL.

The widths of the respective parts of the first blade-side widened portion 550c are larger than a thickness of the end of the lower base 550b connected to the respective parts. The widths of the respective parts of the first blade-side widened portion 550c are larger than the thickness of any part of the lower base 550b.

The width of the first blade-side widened portion 550c in the circumferential direction of the fan center axis CL increases as a distance from the fan center axis CL increases. A shape of the first blade-side widened portion 550c is substantially uniform in any section orthogonal to the fan center axis CL.

The first blade widened portion 550c is closer to an end of the division wall 550 that is closer to the first blade widened portion 550c than to the fan center axis CL, than to the fan center axis CL. The second blade widened portion 550d is positioned on a closer side to a radial-direction end of the division wall 550 that is closer to the second blade widened portion 550d than to the fan center axis CL, than to the fan center axis CL. Here, the radial direction refers to a radial direction of the fan center axis CL.

The second blade-side widened portion 550d is housed in the fan suction space 555, and is fixed to the other end of the lower base 550b in the direction orthogonal to the fan center axis CL. Therefore, the lower base 550d is disposed between the first blade-side widened portion 550c and the second blade-side widened portion 550d. In this manner, the second blade-side widened portion 550d is connected to the lower base 550b, and is disposed at a farther position from the fan center axis CL than the lower base 550b. In other words, in the fan suction space 555, the second blade-side widened portion 550d is disposed at the closer position to the rotation area of the blades 552b than the lower base 550b. The second blade-side widened portion 550d corresponds to a second widened portion.

As shown in FIGS. 7 and 8, a width of the second blade-side widened portion 550d in the circumferential direction of the fan center axis CL is larger than that of any part of the lower base 550b.

Here, widths of respective parts of the second blade-side widened portion 550d will be described. Here, the widths of the respective parts of the second blade-side widened portion 550d refer to widths in the thickness direction of the end of the lower base 550b connected to the respective parts. Here, the respective parts of the second blade-side widened portion 550d are parts obtained by dividing the second blade-side widened portion 550d by multiple planes orthogonal to the center axis CL.

The widths of the respective parts of the second blade-side widened portion 550d are greater than a thickness of the end of the lower base 550b connected to the respective parts. The widths of the respective parts of the second blade-side widened portion 550d are greater than a thickness of any part of the lower base 550b.

The width of the second blade-side widened portion 550d in the circumferential direction of the fan center axis CL increases as a distance from the fan center axis CL increases. A shape of the second blade-side widened portion 550d is substantially unchanged in any section orthogonal to the fan center axis CL.

Since the centrifugal fan 552 rotates relative to the division wall 550, a clearance is formed between the division wall 550 and the rotation area of the centrifugal fan 552. Therefore, the centrifugal fan 552 does not come into contact with the division wall 550 during rotation of the centrifugal fan 552.

Therefore, both of the first blade-side widened portion 550c and the second blade-side widened portion 550d are disposed with clearances from a rotation area of the fan boss 552a, the rotation area of the blades 552b, and a rotation area of the top plate 552c. The lower base 550b is also disposed with clearances from the rotation area of the fan boss 552a, the rotation area of the blades 552b, and the rotation area of the top plate 552c.

Next, actuations of the air conditioning unit 10 and the humidification device 50 in the present embodiment will be described. First, an outline of the actuation of the air conditioning unit 10 will be described. A control device (not shown) calculates a target discharge temperature TAO of conditioned air to be blown into the vehicle compartment, based on a set temperature set by a user, for example. The control device controls actuations of the air conditioning unit 10 and various devices in an air conditioning cycle so that a temperature of the air to be blown into the vehicle compartment approaches the target discharge temperature TAO. In this way, it is possible to achieve suitable temperature adjustment in the vehicle compartment requested by the user.

Next, the actuation of the humidification device 50 will be described. The control device determines whether humidification is requested, based on operation by the user. When the control device determines that the humidification is not requested, the control device fully closes the cold air door 522.

When the control device determines that the humidification is requested, the control device starts humidification process for the inside of the vehicle compartment by the humidification device 50. Specifically, the control device moves the cold air door 522 to a fully open position, actuates the motor 551 of the humidifier blower 40 to rotate the centrifugal fan 552, and actuates the drive member 70 to rotate the adsorber 60. In this way, the humidification operation by the humidification device 50 is achieved.

The control device controls the electric motor 72 of the drive member 70 so that the adsorbent 61 from which the moisture is sufficiently desorbed in the desorption space 541b moves into the hygroscopic space 541a in the adsorber housing unit 54. For example, the control device controls the electric motor 72 so as to move the adsorbent 61 from the desorption space 541b to the hygroscopic space 541a after a lapse of a reference time required for desorbing the moisture from the adsorbent 61 in the desorption space 541b. For example, the electric motor 72 is controlled so as to rotate the adsorber 60 at a predetermined constant rotating speed between 5 rpm and 10 rpm (inclusive). When the adsorber 60 rotates, the adsorber housing unit 54, the first partition member 542, and the second partition member 543 do not rotate.

Here, an actuation state of the humidification device 50 when the control device carries out the humidification process will be described. A part of the cooled air that is cooled by the evaporator 13 to a low temperature of 5° C. and a high relative humidity of 70% is suctioned by a suction force of the humidifier blower 40, and is introduced into the adsorption case 51 through a cold air suction duct 521. The moisture included in the cooled air introduced into the adsorption case 51 is adsorbed onto the adsorbent 61 existing in the hygroscopic space 541a in the adsorber 60. As a result, the cooled air turns into the dehumidified air.

Since the adsorber 60 rotates in the adsorber housing space 541, the adsorbent 61 from which the moisture is sufficiently desorbed in the desorption space 541b in the adsorber 60 moves into the hygroscopic space 541a. In this way, the moisture included in the cooled air introduced into the adsorption case 51 is continuously adsorbed onto the adsorbent 61 existing in the hygroscopic space 541a in the adsorber 60. Then, the dehumidified air passing through the hygroscopic space 541a is suctioned by a suction force of the centrifugal fan 552, and flows into the dehumidified air space 583b in the humidification device 50 through the air emitting unit 56 and the second connecting duct 582. The dehumidified air having flowed into the dehumidified air space 583b then flows into the fan suction space 555 by the suction force of the centrifugal fan 552.

The inside air at a temperature of 25° C. and with a relative humidity of 20% is suctioned by the suction force of the humidifier blower 40, and is introduced from the inside air suction unit 53 into the adsorption case 51. The inside air introduced into the adsorption case 51 is humidified by desorbing the moisture adsorbed onto the adsorbent 61 provided in the desorption space 541b in the adsorber 60, and turns into the humidified air at a temperature of 21° C. and with a relative humidity of 57%.

At this time, since the adsorber 60 rotates in the adsorber housing space 541, the adsorbent 61 onto which the moisture is sufficiently adsorbed in the hygroscopic space 541a in the adsorber 60 moves into the desorption space 541b. In this way, the inside air introduced into the adsorption case 51 is continuously humidified by desorbing the moisture from the adsorbent 61 provided in the hygroscopic space 541a in the adsorber 60. In this manner, dehumidification of the cooled air in the hygroscopic space 541a and humidification of the inside air in the desorption space 541b are achieved simultaneously and continuously. Then, the humidified air passing through the desorption space 541b is suctioned by the suction force of the centrifugal fan 552, and flows into the humidified air space 583a in the humidification device 50 through the air emitting unit 56 and the first connecting duct 581. The humidified air having flowed into the humidified air space 583a is then suctioned by the suction force of the centrifugal fan 552, and flows into the fan suction space 555 in the humidifier blower 40.

Since the space between the air emitting unit 56 and the fan suction space 555 is partitioned by the division wall 550, the humidified air and the dehumidified air hardly mix with each other and are separated from each other in the space.

Therefore, the humidified air and the dehumidified air flowing from the air emitting unit 56 into the humidifier blower 40 flow toward the fan boss 552a in the fan suction space 555, while hardly mixing each other and kept separated from each other as shown as the flow of humidified air shown by a solid-line arrow and the flow of dehumidified air shown by a broken-line arrow in FIGS. 4 and 6.

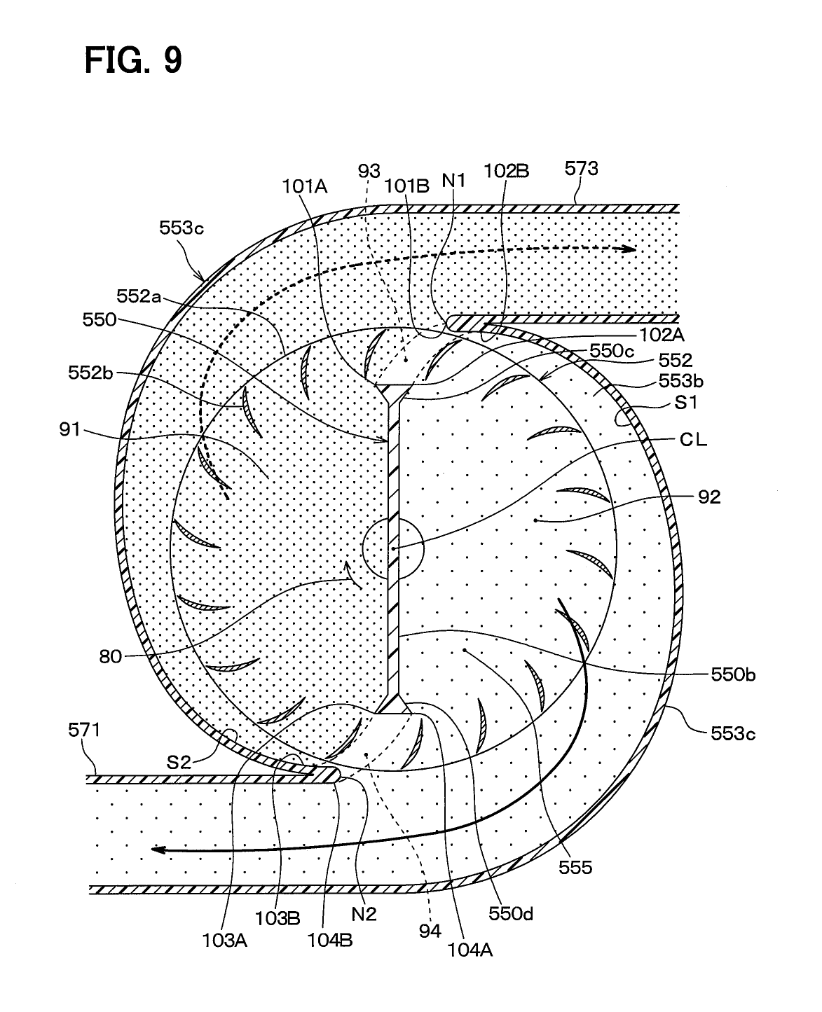

Then, the humidified air and the dehumidified air flow from the fan suction space 555 into the space surrounded by the blades 552b along the fan boss 552a as shown by arrows in FIGS. 7 and 9, while hardly mixing each other and kept separated from each other.

Assuming that air flows into spaces between the blades 552b at a certain time point, the air tries to flow out from outermost ends of the spaces between the blades 552b after the time point. Here, the outermost ends are ends on the farthest sides from the fan center axis CL. Innermost ends are ends on the closest sides to the fan center axis CL.

However, while the air flows in directions away from the fan center axis CL, the centrifugal fan 552 rotates. In the present embodiment, an angle by which the centrifugal fan 552 rotates while the air flows from the innermost ends to the outermost ends of the spaces between the blades 552b is measured in advance by experiments, for example. The rotating speed of the centrifugal fan 552 and a wind speed of the air discharged by the centrifugal fan 552 are proportional to each other. Therefore, the angle hardly depends on the rotating speed of the centrifugal fan 552, but greatly depends on a shape of the centrifugal fan 552, and is between 0° and 90° (exclusive).

The first nose N1 is located so that the deviation angle 61 deviated from the direction 88 toward the first nose N1 to the extending direction 86 of the lower base 550b in the opposite direction from the rotating direction 80 is the same as the measured angle. The second nose N2 is located so that the deviation angle 62 deviated from the direction 89 toward the second nose N2 to the extending direction 87 of the lower base 550b in the opposite direction from the rotating direction 80 is the same as the measured angle.

The second nose N2 is located so that the second deviation angle θ2 deviated from the direction 89 toward the second nose N2 to the extending direction 87 of the lower base 550b in the opposite direction from the rotating direction 80 of the centrifugal fan 552 is the same as the measured angle. Therefore, most part of the humidified air is discharged into the humidification duct 571, and most of the dehumidified air is discharged into the dehumidified air duct 573.

In this manner, as shown in FIG. 9, the lower base 550b, the first blade-side widened portion 550c, and the second blade-side widened portion 550d partition the fan suction space 555 into a space through which the dehumidified air passes and a space through which the humidified air passes on the whole. Hereinafter, the space through which the dehumidified air passes is referred to as “a first suction flow path 91”, and the space through which the humidified air passes is referred to as “a second suction flow path 92”.

In FIG. 9, the area through which the dehumidified air passes is shown with a relatively high density of dots, and the area through which the humidified air passes is shown with a relatively low density of dots. A part of the area through which the dehumidified air passes that belongs to the fan suction space 555 corresponds to the first suction flow path 91. A part of the area through which the humidified air passes that belongs to the fan suction space 555 corresponds to the second suction flow path 92.

As described above, in the present embodiment, the width of the first blade-side widened portion 550c in the circumferential direction of the fan center axis CL is greater than that of the lower base 550b. Therefore, the dehumidified air passing through the first suction flow path 91 and the humidified air passing through the second suction flow path 92 more hardly mix with each other.

Specifically, the dehumidified air at a farthest position 101A from the fan center axis CL of a face of the first blade-side widened portion 550c facing the first suction flow path 91 is discharged basically from a position 101B to an outside of the centrifugal fan 552 by rotation of the centrifugal fan 552. A deviation angle between a direction from the fan center axis CL toward the position 101A and a direction from the fan center axis CL toward the position 101B is equal to the angle θ1.

The humidified air at a farthest position 102A from the fan center axis CL of a face of the first blade-side widened portion 550c facing the second suction flow path 92 is discharged substantially from a position 102B to the outside of the centrifugal fan 552 by rotation of the centrifugal fan 552. A deviation angle between a direction from the fan center axis CL toward the position 102A and a direction from the fan center axis CL toward the position 102B from each other is equal to the angle θ1.

In FIG. 9, a pathway of the dehumidified air from the position 101A to the position 101B and a pathway of the dehumidified air from the position 102A to the position 102B are shown in broken lines. An area 93 encircled with the broken lines has a greater width in the circumferential direction of the fan center axis CL than that of the conventional one by an increase in the circumferential width of the first blade-side widened portion 550c. Although the dehumidified air flowing out of the first suction flow path 91 and the dehumidified air flowing out of the second suction flow path 92 are mixed each other in the area 93, the area 93 has a greater circumferential width, and therefore amounts of air mixed with each other are small. Therefore, the dehumidified air passing through the first suction flow path 91 and the humidified air passing through the second suction flow path 92 more hardly mix with each other in the area 93.

Likewise, the dehumidified air at a farthest position 103A from the fan center axis CL of a face of the second blade-side widened portion 550d facing the first suction flow path 91 is discharged substantially from a position 103B to the outside of the centrifugal fan 552. A deviation angle between a direction from the fan center axis CL toward the position 103A and a direction from the fan center axis CL toward the position 103B is equal to the angle θ2.

The humidified air at a farthest position 104A from the fan center axis CL of a face of the second blade-side widened portion 550d facing the second suction flow path 92 is discharged substantially from a position 104B to the outside of the centrifugal fan 552. A deviation angle between a direction from the fan center axis CL toward the position 104A and a direction from the fan center axis CL toward the position 104B is equal to the angle θ2.

An area 94 is defined by a broken-line pathway of the dehumidified air from the position 103A to the position 103B and by a broken-line pathway of the dehumidified air from the position 104A to the position 104B. The area 94 has a greater width in the circumferential direction of the fan center axis CL than that of the conventional one by an increase in the circumferential width of the second blade-side widened portion 550d. Therefore, the dehumidified air passing through the first suction flow path 91 and the humidified air passing through the second suction flow path 92 more hardly mix with each other in the area 94.

Since the division wall 550 is provided with the first blade-side widened portion 550c and the second blade-side widened portion 550d in this manner, the areas 93 and 94 have greater circumferential widths. As a result, the dehumidified air and the humidified air being mixed each other in the areas 93 and 94 is suppressed.

As described above, in the fan suction space 555, the first blade-side widened portion 550c is disposed at the closer position to the rotation area of the blades 552b than that of the fan boss 552a. Likewise, in the fan suction space 555, the second blade-side widened portion 550d is disposed at the closer position to the rotation area of the blades 552b than that of the fan boss 552a. The widths of the first blade-side widened portion 550c and the second blade-side widened portion 550d in the thickness directions of the ends of the lower base 550b connected to the first blade-side widened portion 550c and the second blade-side widened portion 550d are greater than the thicknesses of the ends.

In this manner, the widths of the blade-side widened portions 550c and 550d in the thickness directions of the ends of the lower base 550b are greater than the thicknesses of the ends. In this way, the blade-side widened portions 550c and 550d separate the first fluid and the second fluid from each other with longer distances than that of the base. Therefore, in the spaces between the blade-side widened portions 550c, 550d and the rotation area of the blades 552b, the first fluid and the second fluid being mixed each other is suppressed. As a result, it is possible to obtain higher performance in separating the first fluid and the second fluid than that of the conventional one.

In the division wall 550, the blade-side widened portions 550c and 550d are at the closest positions to the rotation area of the plurality of blades 552b. With this structure, the blade-side widened portions 550c and 550d separate the first fluid and the second fluid from each other with the longer distances than that of the base, at the closest portions to the rotation area of the plurality of blades 552b. Therefore, it is possible to obtain much higher performance in separating the first fluid and the second fluid.

Each of the blade-side widened portions 550c and 550d has the smaller width in the circumferential direction of the fan center axis CL than a distance between two adjacent blades of the plurality of blades 552b. With this structure, the blade-side widened portions 550c and 550d do not close entire clearances between the two adjacent blades, thereby suppressing increase in pressure losses produce by the blade-side widened portions 550c and 550d.

### Second Embodiment

Next, a second embodiment will be described. The present embodiment is obtained by changing the shapes of the first blade-side widened portion 550c and the second blade-side widened portion 550d in the first embodiment.

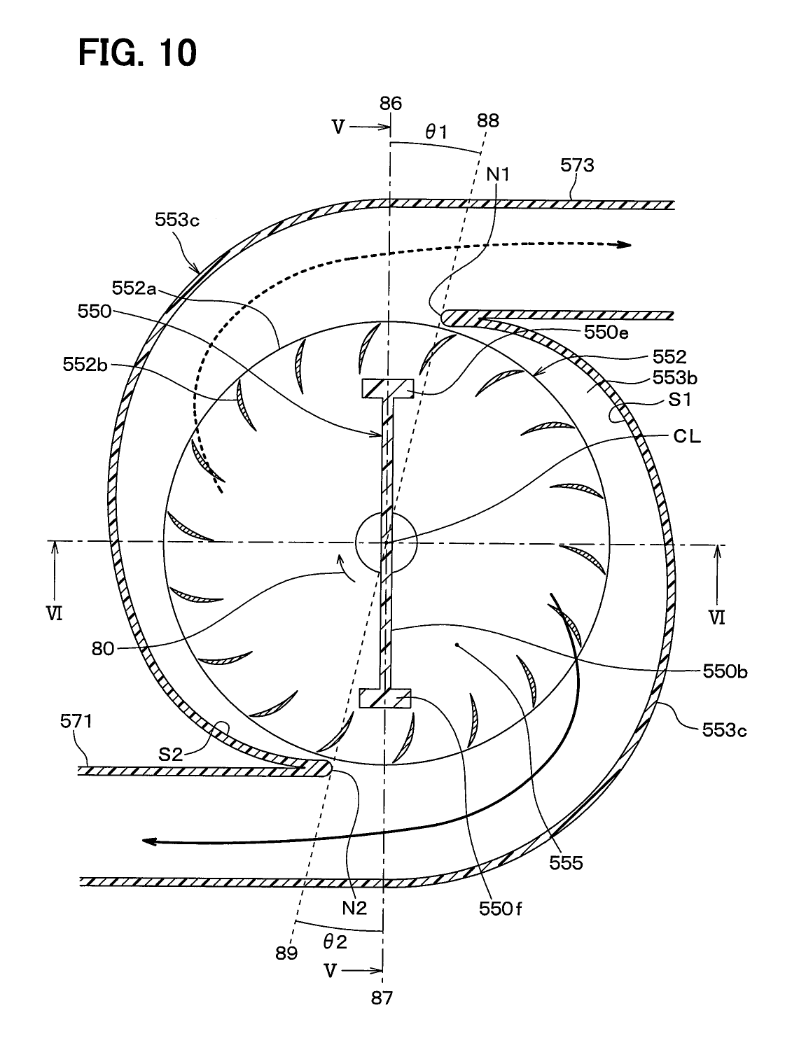

Specifically, as shown in FIG. 10, a division wall 550 of the present embodiment includes a first blade-side widened portion 550e in place of the first blade-side widened portion 550c of the first embodiment, and a second blade-side widened portion 550f in place of the second blade-side widened portion 550d of the first embodiment.

A width of the first blade-side widened portion 550e in a circumferential direction of a fan center axis CL is substantially uniform irrespective of a distance from the fan center axis CL. Other characteristics of the first blade-side widened portion 550e are the same as those of the first blade-side widened portion 550c.

A width of the second blade-side widened portion 550f in the circumferential direction of the fan center axis CL is substantially uniform irrespective of a distance from the fan center axis CL. Other characteristics of the second blade-side widened portion 550f are the same as those of the second blade-side widened portion 550d.

Therefore, the first blade-side widened portion 550e and the second blade-side widened portion 550f have greater widths in the circumferential direction of the fan center axis CL than that of a lower base 550b. Therefore, the division wall 550 in the present embodiment can exert the same effects as those of the division wall 550 in the first embodiment. In the present embodiment, the first blade-side widened portion 550e corresponds to the first widened portion, and the second blade-side widened portion 550f corresponds to the second widened portion.

### Third Embodiment

Next, a third embodiment will be described. The present embodiment is obtained by changing the shapes of the first blade-side widened portion 550c and the second blade-side widened portion 550d in the first embodiment.

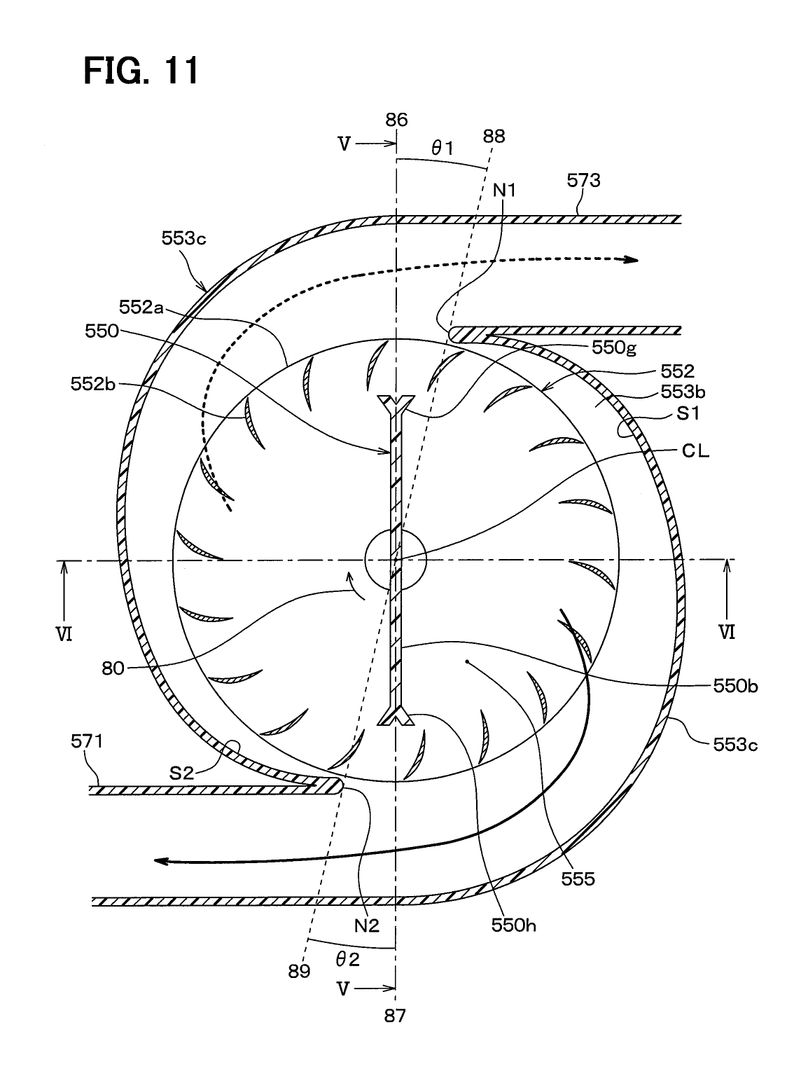

Specifically, as shown in FIG. 11, a division wall 550 in the present embodiment includes a first blade-side widened portion 550g in place of the first blade-side widened portion 550c in the first embodiment, and a second blade-side widened portion 550h in place of the second blade-side widened portion 550d in the first embodiment.

The first blade-side widened portion 550g has a recessed groove formed in its face on an opposite side from a fan center axis CL. Other characteristics of the first blade-side widened portion 550g are the same as those of the first blade-side widened portion 550c. The second blade-side widened portion 550h has a recessed groove formed in its face on an opposite side from the fan center axis CL. Other characteristics of the second blade-side widened portion 550h are the same as those of the second blade-side widened portion 550d.

Therefore, the first blade-side widened portion 550g and the second blade-side widened portion 550h have greater widths in a circumferential direction of the fan center axis CL than that of a lower base 550b. Therefore, the division wall 550 in the present embodiment can exert the same effects as those of the division wall 550 in the first embodiment. In the present embodiment, the first blade-side widened portion 550g corresponds to the first widened portion, and the second blade-side widened portion 550h corresponds to the second widened portion.

### Fourth Embodiment

Next, a fourth embodiment will be described. The present embodiment is obtained by changing the structure of the division wall 550 in the first embodiment.

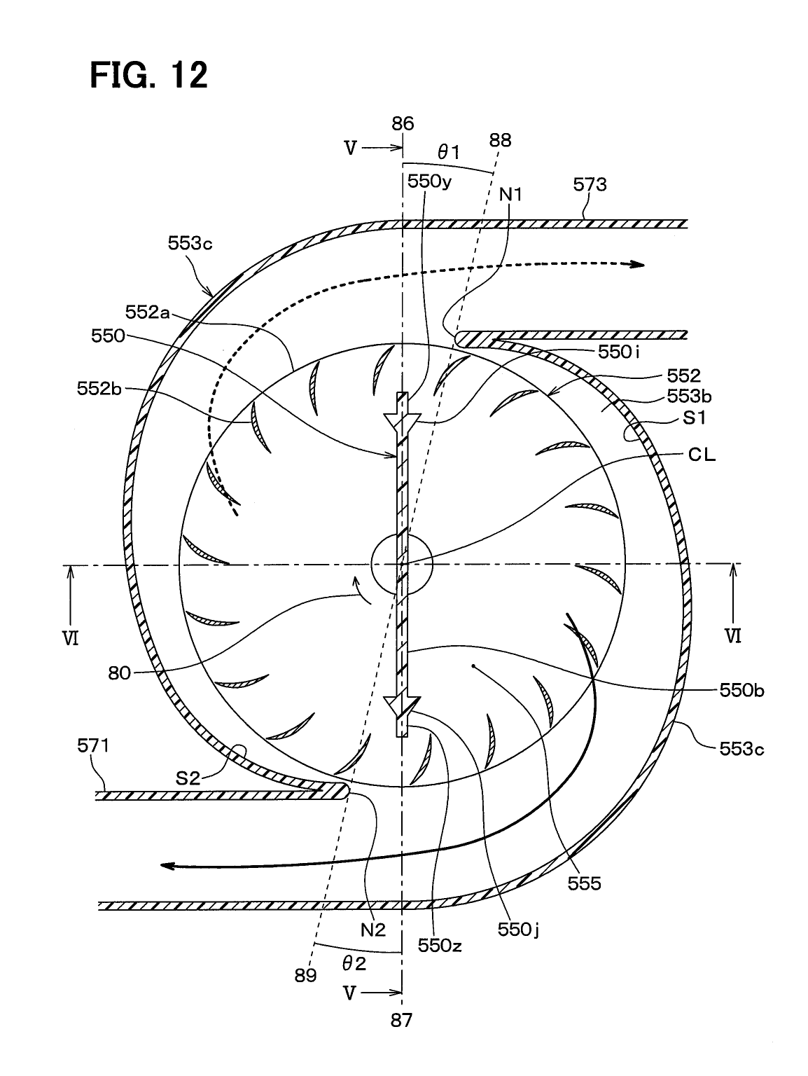

As shown in FIG. 12, the division wall 550 in the present embodiment includes an upper base 550a, a lower base 550b, a first blade-side widened portion 550i, a second blade-side widened portion 550j, a first extension 550y, and a second extension 550z.

Characteristics of the upper base 550a are the same as those of the upper base 550a in the first embodiment. The lower base 550b has a smaller length in a radial direction of a fan center axis CL than that of the lower base 550b in the first embodiment. Other characteristics of the lower base 550b are the same as those of the lower base 550b in the first embodiment.

The first blade-side widened portion 550i is employed in place of the first blade-side widened portion 550c, and a shape of the first blade-side widened portion 550i and how the first blade-side widened portion 550i is attached to the lower base 550b are the same as those of the first blade-side widened portion 550c. However, since the lower base 550b has the smaller length in the radial direction than that in the first embodiment, a distance to the first blade-side widened portion 550i from the fan center axis CL is also shorter than that to the first blade-side widened portion 550c from the fan center axis CL by the difference in the radial length.

The second blade-side widened portion 550j is employed in place of the second blade-side widened portion 550d, and a shape of the second blade-side widened portion 550j and how the second blade-side widened portion 550j is attached to the lower base 550b are the same as those of the second blade-side widened portion 550d. However, since the lower base 550b has the smaller length in the radial direction than that in the first embodiment, a distance to the second blade-side widened portion 550j from the fan center axis CL is also shorter than that to the second blade-side widened portion 550d from the fan center axis CL by the difference in the radial length.

The first extension 550y extends from a face of the first blade-side widened portion 550i on an opposite side from the fan center axis CL in a direction away from the fan center axis CL. A width of the first extension 550y in a circumferential direction of the fan center axis CL is the same as that of the lower base 550b.

The second extension 550z extends from a face of the second blade-side widened portion 550j on an opposite side from the fan center axis CL in a direction away from the fan center axis CL. A width of the second extension 550z in the circumferential direction of the fan center axis CL is the same as that of the lower base 550b.

In this manner, the first blade-side widened portion 550i and the second blade-side widened portion 550j have greater widths in the circumferential direction of the fan center axis CL than that of the lower base 550b. Therefore, the division wall 550 in the present embodiment can exert the same effects as those of the division wall 550 in the first embodiment.

In the present embodiment, the first blade-side widened portion 550i and the second blade-side widened portion 550j are not at outermost ends of the division wall 550 in the radial direction of the fan center axis CL. In this case, however, the same effects as those in the first embodiment are exerted. In the present embodiment, the first blade-side widened portion 550i corresponds to the first widened portion, and the second blade-side widened portion 550j corresponds to the second widened portion.

### Fifth Embodiment

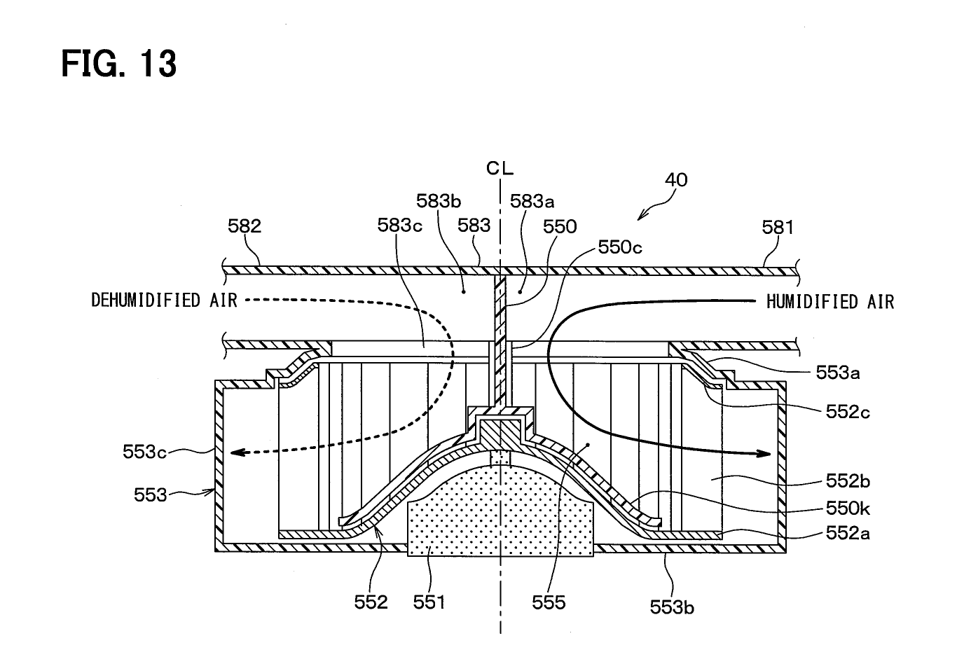

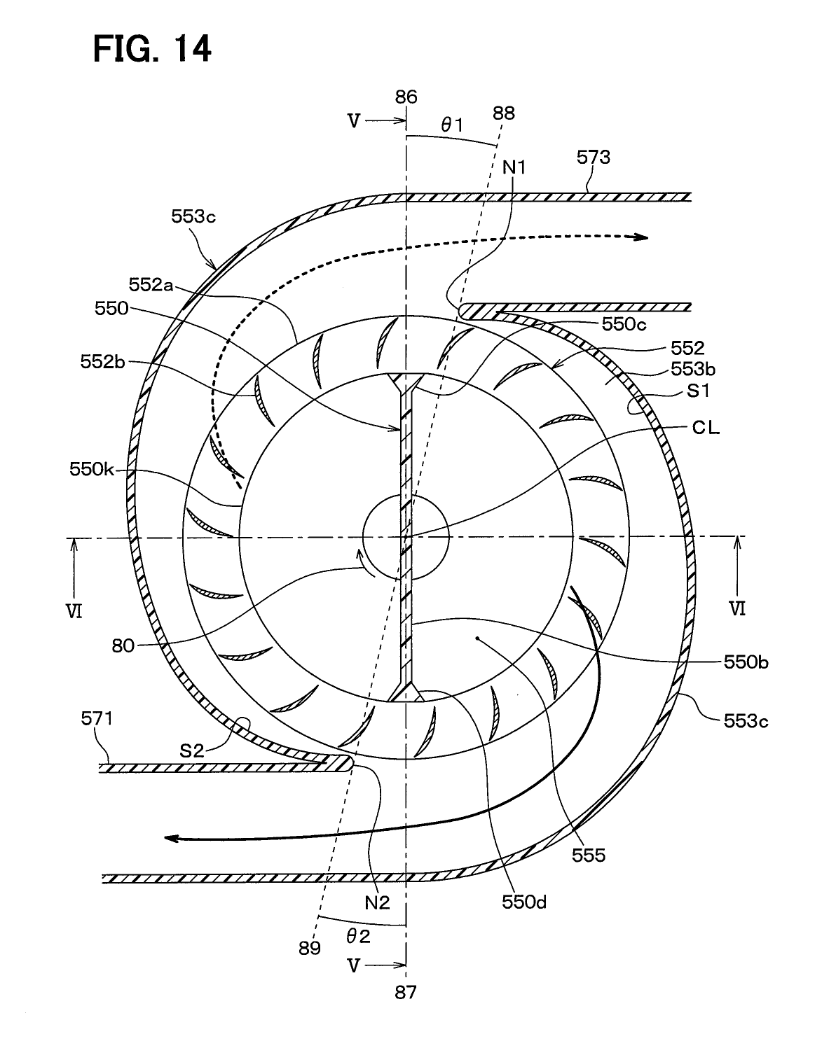

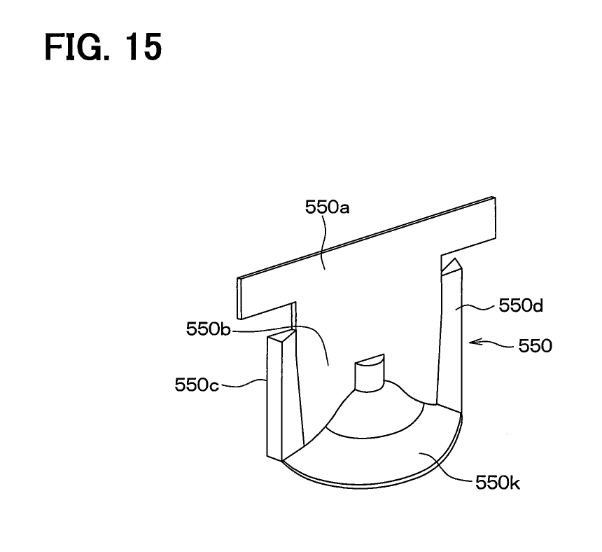

Next, a fifth embodiment will be described. The present embodiment is obtained by changing the structure of the division wall 550 in the first embodiment. As shown in FIGS. 13, 14, and 15, a division wall 550 in the present embodiment includes a boss-side widened portion 550k in addition to an upper base 550a, a lower base 550b, a first blade-side widened portion 550c, a second blade-side widened portion 550d that are the same as those in the first embodiment. The boss-side widened portion 550k may be integrally formed with the upper base 550a, the lower base 550b, the first blade-side widened portion 550c, and the second blade-side widened portion 550d.

The boss-side widened portion 550k is connected to a face of the lower base 550b that is the closest to a rotation area of a fan boss 552a. Therefore, the boss-side widened portion 550k is disposed at a closer position to the rotation area of the fan boss 552a than that of the lower base 550b. In the present embodiment, the fan boss 552a corresponds to a certain part of a centrifugal fan 552. Therefore, the boss-side widened portion 550k is positioned on a closer side to an end of the division wall 550 that is the closest to the fan boss 552a, than to a center of the division wall 550 in a direction parallel to the fan center axis CL.

Here, widths of respective parts of the boss-side widened portion 550k will be described. The widths of the respective parts of the boss-side widened portion 550k refer to widths in a thickness direction of an end of the lower base 550b connected to the respective parts. Here, the respective parts of the boss-side widened portion 550k are parts obtained by dividing the boss-side widened portion 550k by a plurality of planes parallel to both of the thickness direction and the fan center axis CL.

The widths of the respective parts of the boss-side widened portion 550k are greater than a thickness of the end of the lower base 550b connected to the respective parts. The widths of the respective parts of the boss-side widened portion 550k are greater than a thickness of any part of the lower base 550b.

With this structure, the boss-side widened portion 550k separates first fluid and second fluid from each other with a longer distance than that of the lower base 550b. Therefore, in a space between the boss-side widened portion 550k and the fan boss 552a, the first fluid and the second fluid being mixed each other is suppressed. As a result, it is possible to obtain much higher performance in separating the first fluid and the second fluid. Since the lower base 550b separates the first fluid and the second fluid from each other with a shorter distance, the first fluid and the second fluid are likely to mix with each other in a space between the lower base 550b and the fan boss 552a unless the boss-side widened portion 550k is provided.

The boss-side widened portion 550k is a plate having an axisymmetric shape with the fan center axis CL on its symmetry axis. A face of the boss-side widened portion 550k closer to the division wall 550 and a face of the boss-side widened portion 550k closer to the fan boss 552a protrude farther toward the division wall 550 as coming closer to the fan center axis CL. The face of the boss-side widened portion 550k closer to the division wall 550 and the face of the boss-side widened portion 550k closer to the fan boss 552a have shapes conforming to a face of the fan boss 552a closer to the division wall 550.

In the division wall 550, the boss-side widened portion 550k is at the closest position to the rotation area of the fan boss 552a. With this structure, the widened portion separates the first fluid and the second fluid from each other with the relatively long distance at the closest portion to the rotation area of the fan boss 552a. Therefore, it is possible to obtain much higher performance in separating the first fluid and the second fluid.

Moreover, the boss-side widened portion 550k protrudes farther toward a space through which the first fluid passes than that of the lower base 550b, and protrudes farther toward a space through which the second fluid passes than that of the base. In other words, the boss-side widened portion 550k protrudes farther toward one (i.e., the first suction flow path 91) of the plurality of spaces (i.e., the first suction flow path 91 and the second suction flow path 92) partitioned by the division wall 550 than that of the lower base 550b. The boss-side widened portion 550k protrudes farther toward the other (i.e., the second suction flow path 92) of the spaces partitioned by the division wall 550k than that of the lower base 550b. As a result, the width is greater than the thickness of any part of the lower base 550b.

With this structure, a difference in strength between forces that the division wall 550 receives from the first fluid and from the second fluid hardly becomes large than that when this structure is not provided. Therefore, a position of the division wall 550 becomes stable.

### Other Embodiments

The present disclosure is not limited to the above-described embodiments, and may be changed suitably. The above-described respective embodiments are not independent of each other, and may be suitably combined with each other, unless the combination is obviously impossible. In each of the above-described embodiments, the components forming the embodiment are not necessarily essential, unless the component is especially and clearly described as essential or is obviously considered to be essential in principle. In each of the above-described embodiments, when numerical values such as the numbers of components forming the embodiments, numerical values, amounts, and ranges are mentioned, the numerical values are not limited thereto, unless the numerical values are especially and clearly described as unchangeable, or the specific numerical values are obviously unchangeable in principle. Especially, when a plurality of values are shown as examples of an amount, it is possible to employ a value between the plurality of values, unless otherwise specified, or unless it is obviously impossible to employ such a value in principle. In each of the above-described embodiments, when shapes, positional relationships of the components, and the like are mentioned, the shapes and the positional relationships are not limited thereto, unless the shapes and the positional relationships are especially and clearly specified, or are obviously considered to be essential in principle. In the present disclosure, the following modifications to the above-described respective embodiments and modifications in a scope of equivalents to the claims are allowed. It is possible to independently choose to apply or not to apply each of the following modifications to each of the above-described embodiments. In other words, it is possible to apply any combination of any of the following modifications to each of the above-described embodiments.

### (First Modification)

In each of the above-described first to fourth embodiments, a shape of each of the blade-side widened portions 550c, 550d, 550e, 550f, 550g, 550h, 500i, and 500j is substantially the same in any section orthogonal to the fan center axis CL. However, the shape may be different in different sections.

### (Second Modification)

In each of the above-described embodiments, the blower 40 is used as a humidification blower. However, the blower 40 may be used for other purposes. For example, a blower 40 may be disposed in an air conditioning case 11 in place of an air conditioning fan 192. In this case, a centrifugal fan 552 suctions and discharges first fluid and second fluid in an air conditioning case with the first fluid and the second fluid substantially separated from each other.

For example, an inside of an air conditioning case 11 may be partitioned into a space A for discharging first fluid toward a driver's seat in a vehicle compartment and a space B for discharging second fluid toward a passenger's seat in the vehicle compartment. The space A may communicate with a second connecting duct 582, and the space B may communicate with a first connecting duct 581.

In this case, the first fluid and the second fluid may be different in temperature, content ratio between outside air and inside air, or humidity.

### (Third Modification)

Although the sirocco fan is shown as an example of the centrifugal fan 552 in each of the above-described embodiments, the fan boss 552a may be a turbofan. Although the centrifugal fan 552 is shown as an example of the fan in each of the above-described embodiments, the fan may be an axial-flow fan. The fan may be any fan having a function of suctioning and discharging first fluid and second fluid by rotating.

### (Fourth Modification)

Although the lower base 550b is the flat plate in each of the above-described embodiments, the lower base 550b is not necessarily be the flat plate. For example, the lower base 550b may be bent or curved.

### (Fifth Modification)

The fifth embodiment is described above as an example in which the boss-side widened portion 550k is added to the humidifier blower 40 in each of the first to fourth embodiments. However, it is possible to add a boss-side widened portion 550k to the humidifier blower 40 in each of the second to fourth embodiments as well by the same method.

### (Sixth Modification)

The first blade-side widened portion 550c and the second blade-side widened portion 550d may be removed from the division wall 550 in the above-described fifth embodiment.

### (Recapitulation)

According to a first aspect shown in a part or all of the above-described embodiments and modifications, the blower includes the fan and the division wall. The fan rotates relative to the division wall to suction and discharge the first fluid and the second fluid. The division wall is disposed with the clearance from the fan, and partitions the suction space into the space through which the first fluid passes and the space through which the second fluid passes. The division wall includes the base and the widened portion. The base is the plate that leads the first fluid and the second fluid into the suction space. The widened portion is connected to the base in the suction space. In the suction space, the widened portion is disposed at a closer position to the rotation area of the certain part of the fan than the position of the base. The width of the widened portion in a thickness direction of the end of the base connected to the widened portion is greater than the thicknesses of the ends.

According to a second aspect, the fan includes the fan boss and the plurality of blades in the blower according to the first aspect. The fan boss rotates about the center axis relative to the division wall. The plurality of blades are fixed on the one face side of the fan boss, and are disposed at intervals around the suction space, and lead the air in the suction space in the directions away from the center axis by rotating about the center axis. The base extends in the direction away from the center axis in the suction space. In the suction space, the widened portion is disposed at the closer positions to the rotation area of the plurality of blades than the position of the base. The widened portion has a greater width in the circumferential direction of the center axis than that of the ends of the base.

In this manner, the widened portions have greater widths in the circumferential direction of the center axis than that of the ends of the base at the closer positions to the rotation area of the plurality of blades than that of the base. Therefore, in the spaces between the rotation area of the blades and the widened portions, the first fluid and the second fluid being mixed each other is suppressed.

According to a third aspect, in the division wall, the widened portion is at the closest position to the rotation area of the plurality of blades in the blower according to the second aspect. With this structure, the widened portion separates the first fluid and the second fluid from each other with the longer distance than that of the base at the closest portion to the rotation area of the plurality of blades. Therefore, it is possible to obtain much higher performance in separating the first fluid and the second fluid.

According to the third aspect, the widened portion has a smaller width in the circumferential direction of the center axis than the distance between the two adjacent blades of the plurality of blades in the blower according to the second or third aspect. With this structure, it is possible to suppress the increase in the pressure losses produce by the widened portions.

According to a fifth aspect, the fan includes the fan boss and the plurality of blades in the blower according to the first aspect. The fan boss rotates about the center axis relative to the division wall. The plurality of blades are fixed on the one face side of the fan boss, and are disposed at intervals around the suction space, and lead the air in the suction space in directions away from the center axis by rotating about the center axis. The base is a plate extending in the direction toward the fan boss and in the direction away from the center axis in the suction space. In the suction space, the widened portion is disposed at the closer position to the rotation area of the fan boss than the position of the base.

In this manner, the widened portion is disposed at a closer position to the rotation area of the fan boss than that of the base. In other words, the fan boss corresponds to the certain part of the fan. With this structure, in the space between the rotation area of the fan boss and the widened portion, the first fluid and the second fluid being mixed each other is suppressed.

According to a sixth aspect, in the division wall, the widened portion is at the closest position to the rotation area of the fan boss in the blower according to the fifth aspect. With this structure, the widened portion separates the first fluid and the second fluid from each other with a longer distance than that of the base at the closest portion to the rotation area of the fan boss. Therefore, it is possible to obtain much higher performance in separating the first fluid and the second fluid.

According to a seventh aspect, the widened portion protrudes farther toward the space through which the first fluid passes than the base protrudes, and protrudes farther toward the space through which the second fluid passes than the base protrudes in the blower according to the fifth or sixth aspect.

With this structure, the difference in strength between the forces that the division wall 550 receives from the first fluid and from the second fluid is hardly become large than that when this structure is not provided. Therefore, the position of the division wall 550 becomes stable.

What is claimed is:

1. A blower configured to suction and discharge first fluid and second fluid, the blower comprising:
a fan; and
a division wall, wherein
the fan is configured to rotate relative to the division wall to suction and discharge the first fluid and the second fluid,
the division wall is spaced from the fan and positioned in a suction space through which the first fluid and the second fluid are suctioned by the fan and pass, the division wall partitioning the suction space into a space through which the first fluid passes and a space through which the second fluid passes,
the division wall includes a base and a widened portion,
the base is a plate located in the suction space and is configured to guide flows of the first fluid and the second fluid toward the fan,
the widened portion is connected to the base in the suction space,
in the suction space, the widened portion is closer to a rotation area of a certain part of the fan than the base is, and
a width of the widened portion in a direction along a thickness of an end of the base connected to the widened portion is larger than the thickness of the end of the base.

2. The blower according to claim 1, wherein
the fan includes a fan boss and a plurality of blades,
the fan boss is configured to rotate about a center axis relative to the division wall,
the plurality of blades are fixed to one side of the fan boss and arranged around the suction space at intervals,
the plurality of blades are configured to rotate about the center axis to lead air in the suction space in a direction away from the center axis,
the base extends in the suction space in the direction away from the center axis,
in the suction space, the widened portion is closer to a rotation area of the plurality of blades than the base is, and
the widened portion is larger in width in a circumferential direction of the center axis than the end of the base.

3. The blower according to claim 2, wherein
the widened portion is a closest portion of the division wall to the rotation area of the plurality of blades.

4. The blower according to claim 2, wherein
a width of the widened portion in the circumferential direction of the center axis is smaller than a distance between two adjacent blades of the plurality of blades.

5. The blower according to claim 1, wherein
the fan includes a fan boss and a plurality of blades,
the fan boss is configured to rotate about a center axis relative to the division wall,
the plurality of blades are fixed to one side of the fan boss and arranged around the suction space at intervals,
the plurality of blades are configured to rotate about the center axis to lead air in the suction space in a direction away from the center axis,
the base is a plate that extends in the suction space in a direction toward the fan boss and in the direction away from the center axis,
in the suction space, the widened portion is closer to a rotation area of the fan boss than the base is.

6. The blower according to claim 5, wherein
the widened portion is a closest portion of the division wall to the rotation area of the fan boss.

7. The blower according to claim 5, wherein
the widened portion protrudes farther toward the space through which the first fluid passes than the base is, and
the widened portion protrudes farther toward the space through which the second fluid passes than the base is.

8. The blower according to claim 5, wherein
the widened portion protrudes farther toward one of the spaces partitioned by the division wall than the base is, and protrudes farther toward another of the spaces partitioned by the division wall than the base protrudes.

9. The blower according to claim 5, wherein
the widened portion is closer to an end of the division wall than a center of the division wall in a direction parallel to the center axis, the end of the division wall being closest to the fan boss in the division wall.

10. The blower according to claim 1, wherein
the fan is configured to rotate about the center axis relative to the division wall, and
the widened portion is closer to an end of the division wall in a radial direction of the center axis than the widened portion is to the center axis, the widened portion being between the center axis and the end of the division wall.

11. The blower according to claim 1, wherein
the widened portion is a first widened portion,
the division wall further includes a second widened portion,
the second widened portion is connected to the base in the suction space,
in the suction space, the second widened portion is closer to the rotation area of the certain part of the fan than the base is,
the end is a first end,
a width of the second widened portion in a direction along a thickness of a second end of the base connected to the second widened portion is larger than the thickness of the second end,
the first widened portion is connected to one of the ends of the base, and
the second widened portion is connected to another of the ends of the base.
